(19) United States
(12) Patent Application Publication
(10) Pub. No.: US 2024/0396059 A1
(43) Pub. Date: Nov. 28, 2024

(54) BIPOLAR PLATE CAPABLE OF ENHANCING FLUID DISTURBANCE FOR FUEL CELLS

(71) Applicant: Shanghai Jiao Tong University, Shanghai (CN)

(72) Inventors: Shuxin LIAO, Shanghai (CN); Diankai QIU, Shanghai (CN); Peiyun YI, Shanghai (CN); Linfa PENG, Shanghai (CN); Xinmin LAI, Shanghai (CN)

(73) Assignee: Shanghai Jiao Tong University, Shanghai (CN)

(21) Appl. No.: 18/271,475

(22) PCT Filed: Feb. 10, 2023
(86) PCT No.: PCT/CN2023/075389

§ 371 Date: Jul. 10, 2023

(30) Foreign Application Priority Data
Aug. 29, 2022 (CN) 202211040662.2

(51) Int. Cl. H01M 8/0263; H01M 8/0267; H01M 8/0297

(52) U.S. Cl. CPC H01M 8/0263; H01M 8/0267; H01M 8/0297

(57) ABSTRACT

A bipolar plate capable of enhancing fluid disturbance for fuel cells includes an anode plate and a cathode plate. The anode plate and the cathode plate include a plurality of polar plate units. Each of the polar plate units includes a left rib, a left side plate, a middle rib, a right side plate, and a right rib. Each of the ribs are formed by wavy surfaces, and peaks of the wavy surfaces of every two adjacent ribs are spaced apart from each other. Every two adjacent ribs are connected through one side plate, and the side plates are formed by lofted surfaces. The anode plate and the cathode plate are mounted back-to-back and are attached together.

### TECHNICAL FIELD

The invention belongs to the technical field of fuel cells, and relates to a bipolar plate capable of enhancing fluid disturbance for fuel cells.

### DESCRIPTION OF RELATED ART

Hydrogen, as an environmentally friendly green energy source, has received increasingly more attention. The proton exchange membrane fuel cell (PEMFC), as a power device capable of directly converting hydrogen energy into electricity, has the outstanding advantages of quick start in low-temperature environments, low heat radiation, low noise, low emission, high power density and the like, and has broad application prospects in the fields such as transportation, stationary power plants, and aerospace. The PEMFC is typically composed of bipolar plates (BPPs), membrane electrode assemblies (MEAs), sealing elements, and other parts. In fuel cells, the bipolar plate plays the role of structural support and current conduction. The flow field in the bipolar plate can promote uniform distribution of reactants and cooling liquid and allows timely discharge of reaction products, which make the bipolar plate an important component for water and gas management of the fuel cells. Therefore, the structural design of the bipolar plate is of critical importance.

With the continuous development of key technologies, the power density of the PEMFC is significantly improved, but there is still a great challenge to realize the large-scale commercial application of the PEMFC. A flow field with high disturbance can promote mass transfer, water discharge, and heat exchange of fuel cells and remarkably improve the reaction uniformity and output performance of cells, thus having become an important direction of the structural design of bipolar plates.

Upon search of existing technical literature. Chinese Invention Patent No.CN109643809A discloses an engaged ultrathin metal bipolar plate and a three-dimensional flow field thereof. In this invention, the fluid disturbance in fuel cells is enhanced by a trapezoidal cross-section and a passage structure with a wavy bottom surface. However, such a design reserves the traditional rib/channel structure, resulting in a compressed gas diffusion layer (GDL) beneath the ribs, which limits the improvement of the water-gas transmission performance of the whole flow field. Korean Invention Patent No.KR102034457B1 discloses a gas flow separation plate for fuel cells. In this invention, gas flow regions are effectively separated from liquid flow regions through multiple three-dimensional through-hole units in the plate to prevent a reactant transfer path from being blocked, and the gas flow path is changed through the through-hole units to form a turbulent condition beneficial to water discharge. However, the gas flow separation plate does not have a sealing performance, which makes it impossible to be used as a bipolar plate for fuel cell stacks along, and it is also high in production cost. Chinese Invention Patent No.CN113823809A discloses a flow field design for fuel cell bipolar plates. In this invention, a cross-shaped protrusion array is designed on the surface of each single polar plate, and meshed gas flow paths are formed between protrusions to enhance forced convection of the flow field and improve the mass transfer effect and heat exchange efficiency of the fuel cells. However, due to the fact that the bottom surfaces of the bipolar plate are simple planes and the gas flow paths have the same section, it is difficult to realize forced convection in the direction perpendicular to the reaction plane. As mentioned above, although existing bipolar plates with high disturbance for fuel cells can enhance fluid disturbance to some extent, they still have many problems, for example, they do not have sealing performance, or have a high production cost, or have a limited improvement effect on fluid disturbance, which further limits the actual application of the existing bipolar plates.

### SUMMARY

The objective of the invention is to overcome the defects of the prior art by providing a bipolar plate capable of enhancing fluid disturbance for fuel cells, which has good sealing performance, can enhance fluid disturbance, improve water and gas management of fuel cells, and is easy to manufacture and assemble.

The objective of the invention may be fulfilled through the following technical solution.

A bipolar plate capable of enhancing fluid disturbance for fuel cells comprises an anode plate and a cathode plate, wherein the anode plate and the cathode plate comprise a plurality of polar plate units; each of the polar plate units comprises a left rib, a left side plate, a middle rib, a right side plate, and a right rib; the left rib, the middle rib, and the right rib are formed by wavy surfaces; the left side plate is connected to the left rib and the middle rib, and the right side plate is connected to the right rib and the middle rib.

Further, a peak of the wavy surface of the left rib and a peak of the wavy surface of the right rib are identical and are spaced apart from a peak of the wavy surface of the middle rib.

Further, the wavy surfaces of the left rib, the middle rib, and the right rib are designed according to a cosine function, a sine function, a Gaussian function, or a polynomial function.

Preferably, a describing function of the wavy surfaces of the left rib and the right rib is ƒ₁, a describing function of the wavy surface of the middle rib is ƒ₂, the distance from the peaks of the wavy surfaces of the left and right ribs to the peak of the middle rib is L₁, and the describing functions of the wavy surfaces of the left and right ribs and the middle rib can be different, such as cosine functions:

$${f}_{1} = 0 \text{.5} A cos ( 2 π x {L}_{2}^{- 1} ) , x ∈ [ 0 , {L}_{2} ]$$

$${f}_{2} = - 0 \text{.5} A cos ( 2 π {xL}_{2}^{- 1} ) , x ∈ [ 0 , {L}_{2} ]$$

Where. A is the maximum height of a flow field corresponding to the polar plate units, and L₂ is the length of the polar plate units.

The width of the left rib is W₁₁, the width of the left side plate is W₂₁, the width of the middle rib is W₁₂, the width of the right side plate is W₂₂, the width of the right rib is W₁₃, and the thicknesses of the left rib, the left side plate, the middle rib, the right side plate, and the right rib are all t.

Preferably, the distance from the peaks of the wavy surfaces of the left rib and the right rib to the peak of the wavy surface of the middle rib, and the length and height of the polar plate units can be adjusted as needed.

Preferably, the widths and thicknesses of the left rib, the left side plate, the middle rib, the right side plate, and the right rib can be adjusted as needed.

Further, the left side plate and the right side plate are formed by lofted surfaces.

Further, the lofted surface of the left side plate is constructed with a contour of the left rib and a contour of the middle rib as guide paths, and the lofted surface of the right side plate is constructed with a contour of the right rib and a contour of the middle rib as guide paths.

Further, auxiliary constraint paths are set on the guide paths of the lofted surface of the left side plate based on the contour of the left rib and the contour of the middle rib (the describing functions of the wavy surfaces of the left rib and the middle rib), and auxiliary constraint paths are set on the guide paths of the lofted surface of the right side plate based on the contour of the right rib and the contour of the middle rib (the describing functions of the wavy surfaces of the right rib and the middle rib).

Further, the anode plate and the cathode plate comprise one type of polar plate units which are arranged periodically, or multiple types of polar plate units which are arranged in a mixed manner.

Further, the anode plate and the cathode plate are mounted back-to-back, troughs of the anode plate and the cathode plate are attached together, and the anode plate and the cathode plate are welded together in a contact area to form an integrated bipolar plate structure.

Preferably, the anode plate and the cathode plate are metal alloy sheets, such as stainless steel sheets or titanium alloy sheets, obtained through stamping, and the integrated bipolar plate structure is obtained through laser welding or resistance spot-welding.

Preferably, the installation manner of the anode plate and the cathode plate can be adjusted in the direction of the reaction plane according to the flow resistance of a cooling flow field, the contact resistance of the bipolar plate, the height of the bipolar plate, and other design requirements.

Further, anodic reactant flow regions in the adjacent polar plate units are connected, cathodic reactant regions in the adjacent polar plate units are connected, and cooling liquid flow regions in the adjacent polar plate units are connected.

Further, the flow region on the upper surface of the anode plate forms an anodic flow field of the bipolar plate, the flow region on the lower surface of the cathode plate forms a cathodic flow field of the bipolar plate, and the flow region between the lower surface of the anode plate and the upper surface of the cathode plate forms a cooling flow field of the bipolar plate.

Preferably, a cathodic reactant flow direction and an anodic reactant flow direction in the bipolar plate are opposite to each other, and are perpendicular to a cooling fluid flow direction.

Preferably, a cathodic reactant in the bipolar plate is hydrogen, and an anodic reactant in the bipolar plate is air/oxygen.

Compared with the prior art, the invention has the following advantages:
(1) The bipolar plate can realize fluid shunting and collision, generate forced convection perpendicular to the reaction plane, and remarkably enhance multi-directional disturbance of fluid, thus being of great significance in improving the mass transfer characteristics of the flow fields and the heat-exchange efficiency;
(2) The sealing performance of the bipolar plate is guaranteed; by connecting the anode plate and the cathode plate back-to-back, the anodic flow field, cathodic flow field, and cooling flow field with high disturbance can be formed; compared with the prior art, the bipolar plate can save materials and is more suitable for constructing high-power fuel cell stacks;
(3) The bipolar plate is constructed from smooth wavy surfaces and lofted surfaces, thus being simple in structure, easy to machine, high in yield, and suitable for mass production based on existing manufacturing techniques.

### BRIEF DESCRIPTION OF THE DRAWINGS

FIG. 1 is an overall structural view of a bipolar plate in Embodiment 1 of the invention;

FIG. 2 is a structural view of a polar plate unit in Embodiment 1 of the invention;

FIG. 3 is a front structural view of the bipolar plate in Embodiment 1 of the invention;

FIG. 4 is a left structural view of the bipolar plate in Embodiment 1 of the invention;

FIG. 5 is a front structural view of the polar plate unit in Embodiment 1 of the invention;

FIG. 6 is a top structural view of the polar plate unit in Embodiment 1 of the invention;

FIG. 7 is a schematic diagram of the flowing manner of an anodic reactant in Embodiment 1 of the invention;

FIG. 8 is a schematic diagram of the flowing manner of a cathodic reactant in Embodiment 1 of the invention;

FIG. 9 is a schematic diagram of the flowing manner of cooling liquid in Embodiment 1 of the invention;

FIG. 10 is a comparison diagram of the oxygen (O₂) mass fraction of a catalyst layer in a fuel cell using the bipolar plate (a) in Embodiment 1 of the invention and the oxygen mass fraction of a catalyst layer in a fuel cell using a traditional bipolar plate (b);

FIG. 11 is a comparison diagram of the water (H₂O) mass fraction of a GDL/BPP contact layer in the fuel cell using the bipolar plate (a) in Embodiment 1 of the invention and the water mass fraction of a GDL/BPP contact layer in the fuel cell using the traditional bipolar plate (b);

FIG. 12 is an overall structural view of a bipolar plate in Embodiment 2 of the invention;

FIG. 13 is a structural view of a polar plate unit in Embodiment 2 of the invention;

FIG. 14 is a front structural view of the bipolar plate in Embodiment 2 of the invention;

FIG. 15 is a left structural view of the bipolar plate in Embodiment 2 of the invention;

FIG. 16 is a front structural view of the polar plate unit in Embodiment 2 of the invention;

FIG. 17 is a top structural view of the polar plate unit in Embodiment 2 of the invention.

Reference signs: 1, anode plate; 2, cathode plate; 3, polar plate unit; 311, left rib; 312, middle rib; 313, right rib; 321, left side plate; 322, right side plate.

### DESCRIPTION OF THE EMBODIMENTS

The invention will be described in detail below in conjunction with the accompanying drawings and specific embodiments. The following embodiments are implemented based on the technical solution of the invention and provide a detailed implementation and a specific operating process, but the protection scope of the invention is not limited to the following embodiments.

### Embodiment 1

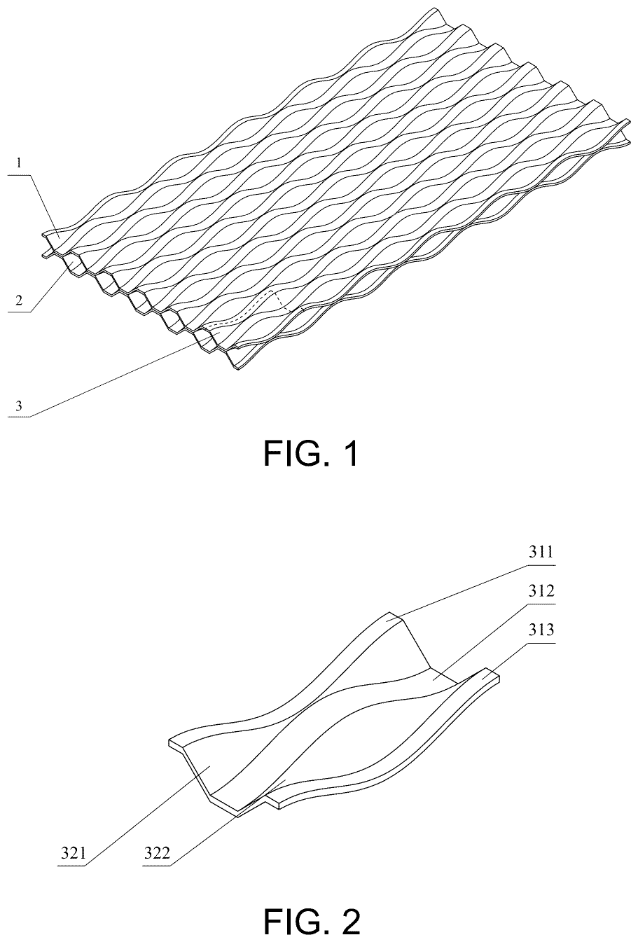

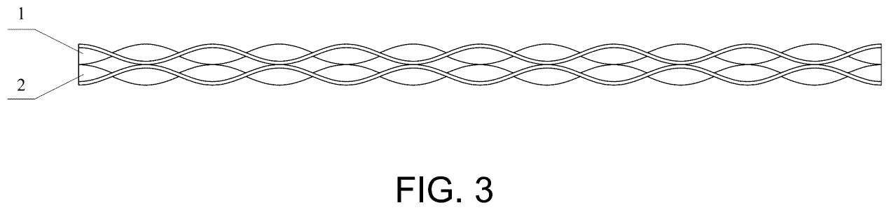

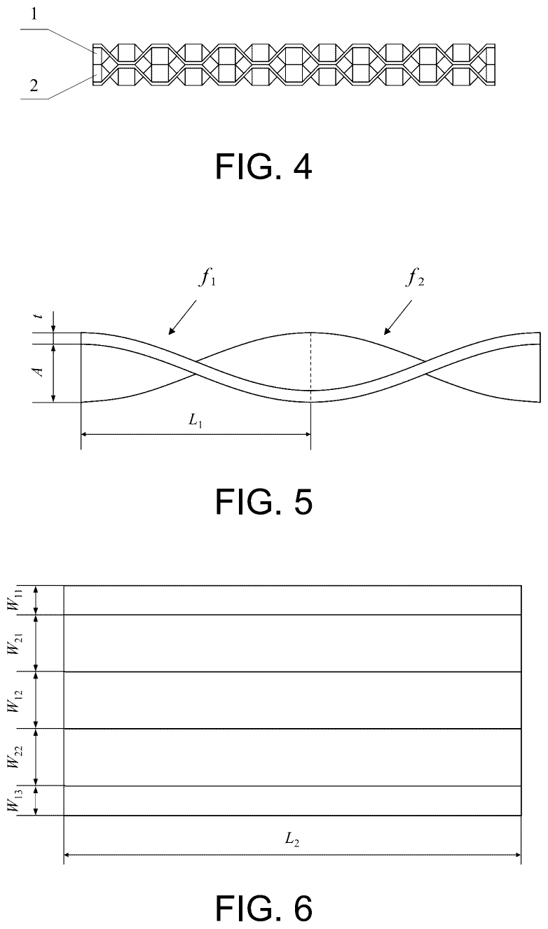

As shown in FIG. 1 to FIG. 4, a bipolar plate capable of enhancing fluid disturbance for fuel cells comprises an anode plate 1 and a cathode plate 2, wherein the anode plate 1 and the cathode plate 2 each comprise a plurality of polar plate units 3; each polar plate unit 3 comprises a left rib 311, a left side plate 321, a middle rib 312, a right side plate 322, and a right rib 313, wherein the left rib 311, the middle rib 312, and the right rib 313 are formed by wavy surfaces, the left rib 311 and the middle rib 312 are connected through the left side plate 321, the right rib 313, and the middle rib 312 are connected through the right side plate 322, and the left side plate 321 and the right side plate 322 are formed by lofted surfaces.

As shown in FIG. 2 and FIG. 5, a describing function of the wavy surfaces of the left rib 311 and the right rib 313 is ƒ₁, a describing function of the wavy surface of the middle rib 312 is ƒ₂, the distance from the peaks of the wavy surfaces of the left rib 311 and the right rib 313 to the peak of the wavy surface of the middle rib 312 is 2 mm, and the describing functions ƒ₁ and ƒ₂ are as follows:

$${f}_{1} = 0.25 cos ( 0.57 π x ) , x ∈ [ 0 , 4 ]$$

$${f}_{2} = - 0.25 cos ( 0.5 π x ) , x ∈ [ 0 , 4 ]$$

Where, the maximum height of a flow field corresponding to the polar plate units 3 is 0.5 mm, and the length of the polar plate units 3 is 4 mm.

As shown in FIG. 2, the left side plate 321 is located between the left rib 311 and the middle rib 312, and the lofted surface of the left side plate 321 is constructed with the contour of the left rib 311 and the contour of the middle rib 312 as guide paths; and the right side plate 322 is located between the right rib 313 and the middle rib 312, and the lofted surface of the right side plate 322 is constructed with the contour of the right rib 313 and the contour of the middle rib 312 as guide paths.

As shown in FIG. 6, the widths of the left rib 311, the left side plate 321, the middle rib 312, the right side plate 322, and the right rib 313 in each polar plate unit 3 are 0.25 mm, 0.5 mm, 0.5 mm. 0.5 mm, and 0.25 mm respectively, and the thicknesses of the left rib 311, the left side plate 321, the middle rib 312, the right side plate 322, and the right rib 313 in each polar plate unit 3 are all 0.1 mm.

As shown in FIG. 1, the anode plate 1 and the cathode plate 2 comprise identical polar plate units 3 which are arranged periodically, the anode plate 1 and the cathode plate 2 are mounted back-to-back, troughs of the anode plate 1 and the cathode plate 2 are attached together, and the anode plate 1 and the cathode plate 2 form an integrated bipolar plate structure through laser welding.

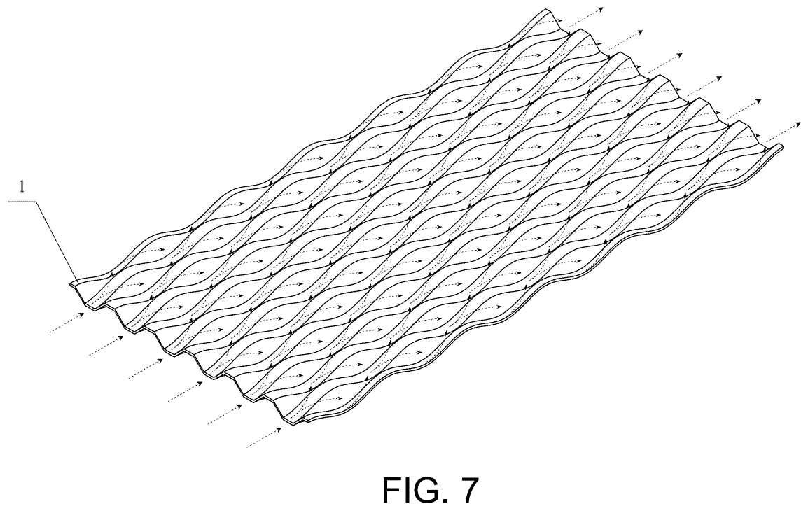

As shown in FIG. 7, the flow region on the upper surface of the anode plate 1 forms an anodic flow field of the bipolar plate, and anodic reactant flow regions in the adjacent polar plate units 3 are connected.

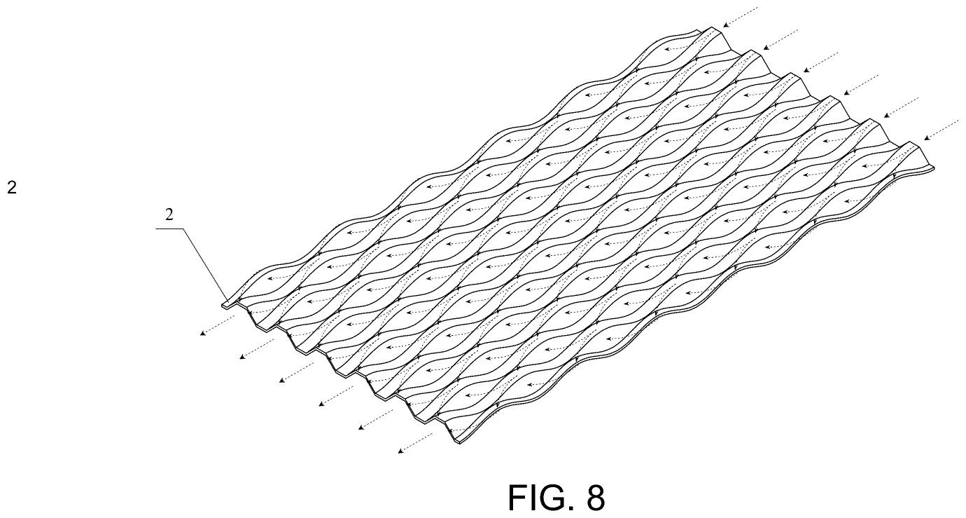

As shown in FIG. 8, a flow region on a lower surface of the cathode plate 2 forms a cathodic flow field of the bipolar plate, cathodic reactant flow regions in the adjacent bipolar plate units 3 are connected, and the flow direction of a cathodic reactant is opposite to the flow direction of an anodic reactant.

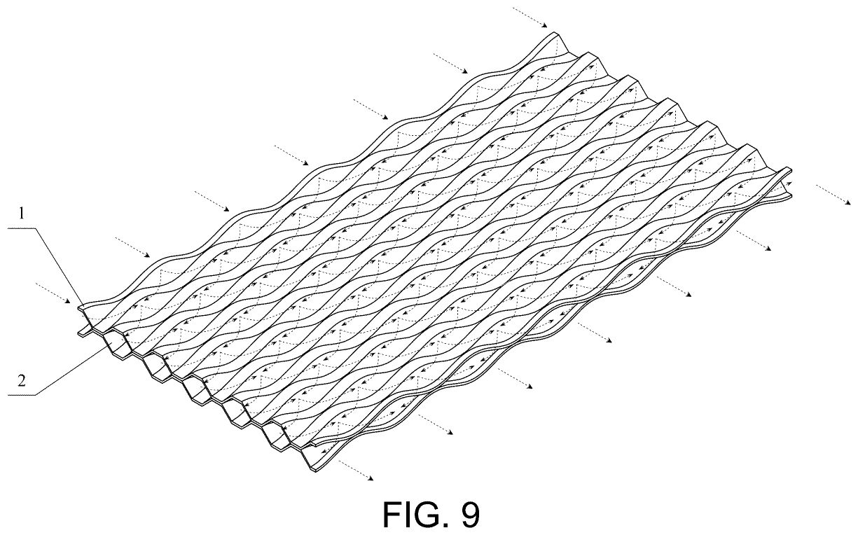

As shown in FIG. 9, the flow region between a lower surface of the anode plate 1 and the upper surface of the cathode plate 2 forms a cooling flow field of the bipolar plate, cooling liquid flow regions in the adjacent polar plate units 3 are connected, and the flow direction of cooling liquid is perpendicular to the flow direction of reactants.

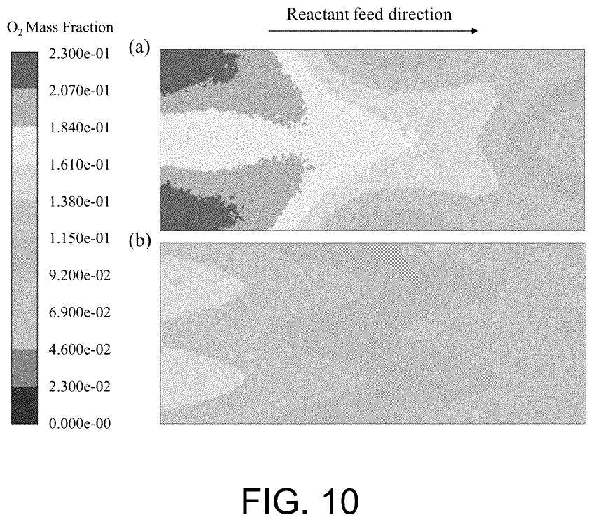

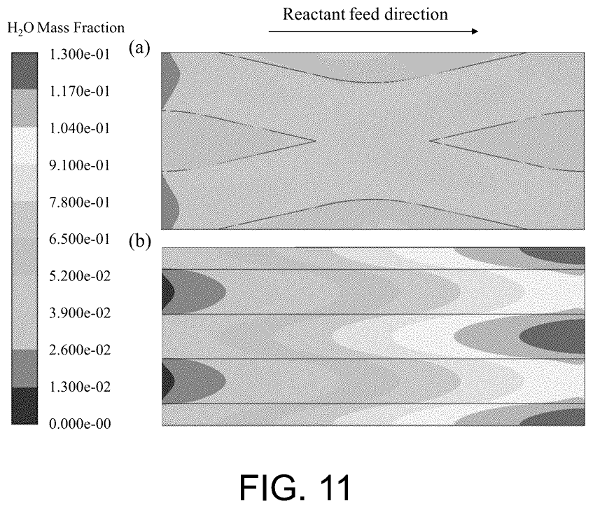

The bipolar plate in this embodiment is compared with a traditional bipolar plate with parallel flow fields and the same reaction area, and ANSYS FLUENT is used for simulation analysis. As shown in FIG. 10, by comparing the distribution of the oxygen (reactant) mass fraction of a catalyst layer in a fuel cell using the bipolar plate (a) in this embodiment with the distribution of the oxygen (reactant) mass fraction of a catalyst layer in a fuel cell using the traditional bipolar plate (b), it can be seen that the oxygen mass fraction in (a) of FIG. 10 is obviously higher than that in (b) of FIG. 10, indicating that the bipolar plate in this embodiment can provide more oxygen for the fuel cell, thus effectively improving the output performance of the fuel cell. The oxygen mass fraction of all nodes in the two sections in (a) and (b) of FIG. 10 are statistically analyzed, and the result indicates that the bipolar plate in this embodiment can improve the average mass fraction of oxygen in the catalyst layer of the fuel cell by 11.32%. In addition, it can be seen from FIG. 11, which illustrates comparison diagrams of the distribution of the water (product) mass fraction of a GDL/BPP contact layer in the fuel cell using the bipolar plate (a) in this embodiment and the distribution of the water mass fraction of a GDL/BPP contact layer in the fuel cell using the traditional bipolar plate (b), that the mass fraction of water in (a) of FIG. 11 is obviously lower than that in (b) of FIG. 11, indicating that the bipolar plate in this embodiment can discharge water (product) in the fuel cell more timely, thus reducing the blockage degree of a reactant passage, reducing the polarization of mass transfer, and realizing better output performance of the fuel cell. Further, the water contents of all nodes in the two sections in (a) and (b) of FIG. 11 are statistically analyzed, the result indicates that the bipolar plate in this embodiment can reduce the average mass fraction of water (product) in the GDL/BPP contact layer by 7.42%. Further, it can be seen, in conjunction with the distribution patterns of oxygen and water in FIG. 10 and FIG. 11, that the bipolar plate in this embodiment also improves the distribution uniformity of the reactant and the product, which is beneficial for improving the operating stability of the fuel cell.

### Embodiment 2

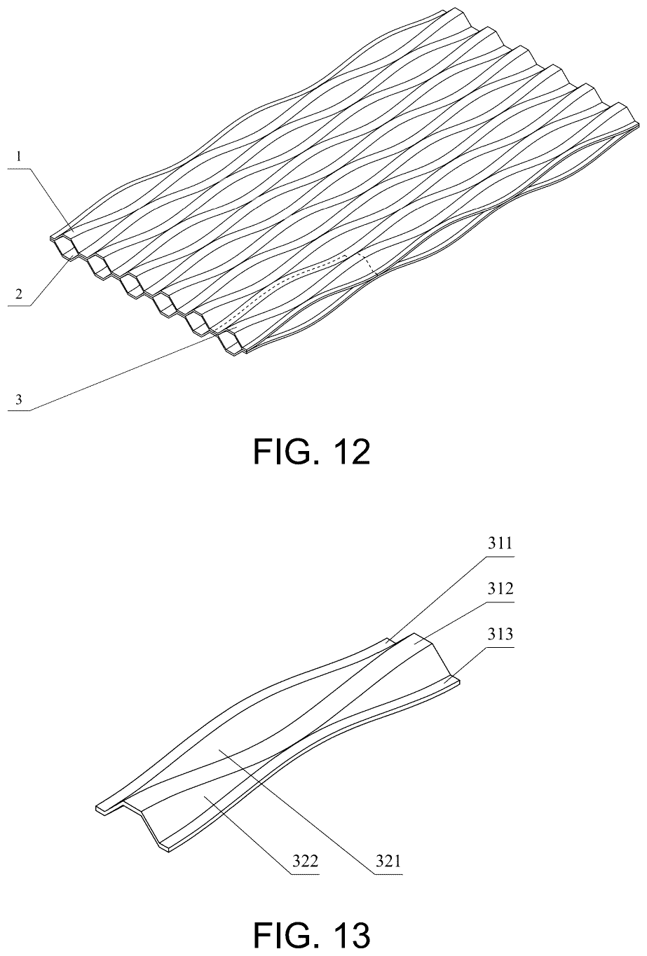

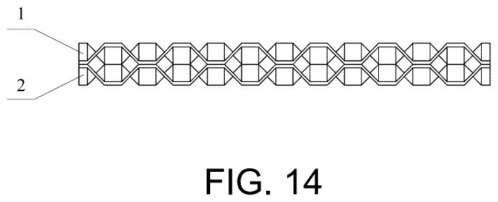

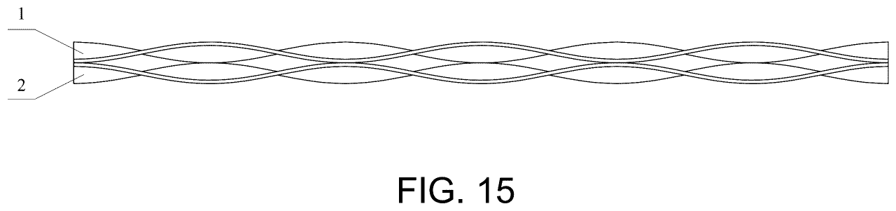

As shown in FIG. 12 to FIG. 15, a bipolar plate capable of enhancing fluid disturbance for fuel cells comprises an anode plate 1 and a cathode plate 2, wherein the anode plate 1 and the cathode plate 2 comprise a plurality of polar plate units 3; each polar plate unit 3 comprises a left rib 311, a left side plate 321, a middle rib 312, a right side plate 322, and a right rib 313, wherein the left rib 311, the middle rib 312, and the right rib 313 are formed by wavy surfaces, the left rib 311 and the middle rib 312 are connected through the left side plate 321, the right rib 313, and the middle rib 312 are connected through the right side plate 322, and the left side plate 321 and the right side plate 322 are formed by lofted surfaces.

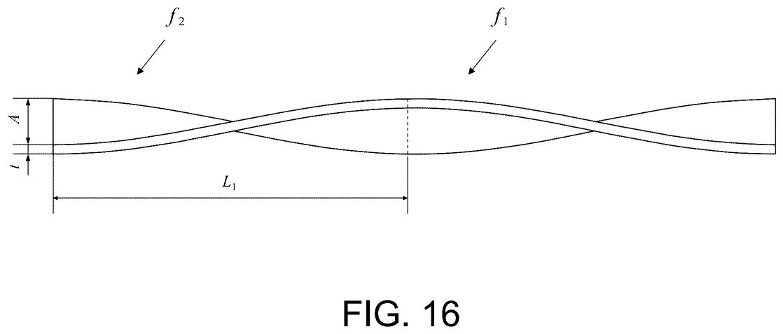

As shown in FIG. 13 and FIG. 16, a describing function of the wavy surfaces of the left rib 311 and the right rib 313 is ƒ₁, a describing function of the wavy surface of the middle rib 312 is ƒ₂, the distance from the peaks of the wavy surfaces of the left rib 311 and the right rib 313 to the peak of the wavy surface of the middle rib 312 is 4 mm, and the describing functions ƒ₁ and ƒ₂ are as follows:

$${f}_{1} = - 0.25 cos ( 0 \text{.25} π x ) , x ∈ [ 0 , 8 ]$$

$${f}_{2} = 0.25 cos ( 0 \text{.25} π x ) , x ∈ [ 0 , 8 ]$$

Where, the maximum height of a flow field corresponding to the polar plate units 3 is 0.5 mm, and the length of the polar plate units 3 is 8 mm.

As shown in FIG. 13, the left side plate 321 is located between the left rib 311 and the middle rib 312, and the lofted surface of the left side plate 321 is constructed with the contour of the left rib 311 and the contour of the middle rib 312 as guide paths; and the right side plate 322 is located between the right rib 313 and the middle rib 312, and the lofted surface of the right side plate 322 is constructed with the contour of the right rib 313 and the contour of the middle rib 312 as guide paths.

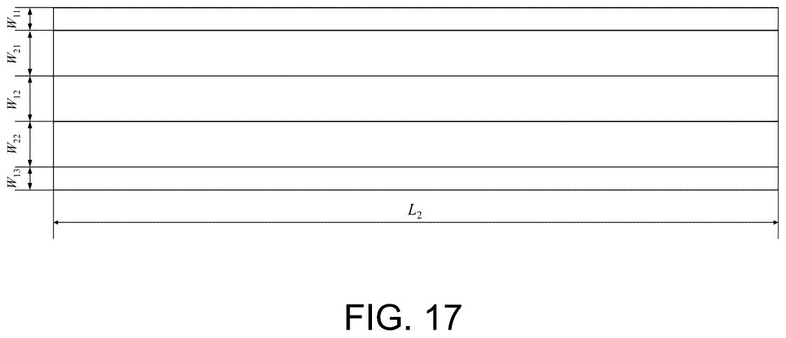

As shown in FIG. 17, the widths of the left rib 311, the left side plate 321, the middle rib 312, the right side plate 322, and the right rib 313 in each polar plate unit 3 are 0.25 mm, 0.5 mm. 0.5 mm. 0.5 mm, and 0.25 mm respectively, and the thicknesses of the left rib 311, the left side plate 321, the middle rib 312, the right side plate 322, and the right rib 313 in each polar plate unit 3 are all 0.1 mm.

The installation of the anode plate 1 and the cathode plate 2, the formation of the anodic flow field, the cathodic flow field and the cooling flow field, and the corresponding fluid flowing manner in Embodiment 2 are the same as those in Embodiment 1, and thus will no longer be detailed here.

Those ordinarily skilled in the art can understand and use the invention with reference to the description of the above embodiments. Any skilled in the art can easily make various amendments to these embodiments and apply the general principle described here to other embodiments without creative labor. Therefore, the invention is not limited to the above embodiments, and all improvements and amendments made by those skilled in the art according to the disclosure of the invention without departing from the scope of the invention should fall within the protection scope of the invention.

1. A bipolar plate capable of enhancing fluid disturbance for fuel cells, comprising an anode plate and a cathode plate, wherein the anode plate and the cathode plate comprise a plurality of polar plate units; each of the polar plate units comprises a left rib, a left side plate, a middle rib, a right side plate, and a right rib; the left rib, the middle rib, and the right rib are formed by wavy surfaces; the left side plate is connected to the left rib and the middle rib, and the right side plate is connected to the right rib and the middle rib.

2. The bipolar plate capable of enhancing fluid disturbance for fuel cells according to claim 1, wherein a peak of the wavy surface of the left rib and a peak of the wavy surface of the right rib are identical and are spaced apart from a peak of the wavy surface of the middle rib.

3. The bipolar plate capable of enhancing fluid disturbance for fuel cells according to claim 1, wherein the wavy surfaces of the left rib, the middle rib, and the right rib are designed according to a cosine function, a sine function, a Gaussian function, or a polynomial function.

4. The bipolar plate capable of enhancing fluid disturbance for fuel cells according to claim 1, wherein the left side plate and the right side plate are formed by lofted surfaces.

5. The bipolar plate capable of enhancing fluid disturbance for fuel cells according to claim 4, wherein the lofted surface of the left side plate is constructed with a contour of the left rib and a contour of the middle rib as guide paths, and the lofted surface of the right side plate is constructed with a contour of the right rib and a contour of the middle rib as guide paths.

6. The bipolar plate capable of enhancing fluid disturbance for fuel cells according to claim 5, wherein auxiliary constraint paths are set on the guide paths of the lofted surface of the left side plate based on the contour of the left rib and the contour of the middle rib, and auxiliary constraint paths are set on the guide paths of the lofted surface of the right side plate based on the contour of the right rib and the contour of the middle rib.

7. The bipolar plate capable of enhancing fluid disturbance for fuel cells according to claim 1, wherein the anode plate and the cathode plate comprise one type of polar plate units arranged periodically, or multiple types of polar plate units arranged in a mixed manner.

8. The bipolar plate capable of enhancing fluid disturbance for fuel cells according to claim 1, wherein the anode plate and the cathode plate are mounted back-to-back, troughs of the anode plate and the cathode plate are attached together, and the anode plate and the cathode plate are welded together in a contact area to form an integrated bipolar plate structure.

9. The bipolar plate capable of enhancing fluid disturbance for fuel cells according to claim 1, wherein anodic reactant flow regions in the adjacent polar plate units are connected, cathodic reactant regions in the adjacent polar plate units are connected, and cooling liquid flow regions in the adjacent polar plate units are connected.

10. The bipolar plate capable of enhancing fluid disturbance for fuel cells according to claim 1, wherein a flow region on an upper surface of the anode plate form an anodic flow field of the bipolar plate, a flow region on a lower surface of the cathode plate forms a cathodic flow field of the bipolar plate, and a flow region between a lower surface of the anode plate and an upper surface of the cathode plate forms a cooling flow field of the bipolar plate.
